(19) United States
(12) Patent Application Publication
(10) Pub. No.: US 2015/0263810 A1
(43) Pub. Date: Sep. 17, 2015

(54) Passive Optical Networking with Daisy-Chaining

(71) Applicants: Pook-Ping Yao, Coquitlam (CA); Byron Matthew Thom, Vancouver (CA)

(72) Inventors: Pook-Ping Yao, Coquitlam (CA); Byron Matthew Thom, Vancouver (CA)

(21) Appl. No.: 14/214,886

(22) Filed: Mar. 15, 2014

(51) Int. Cl. H04B 10/27; H04B 10/40; H04B 10/25

(52) U.S. Cl. CPC H04B 10/27; H04B 10/2504; H04B 10/40

(57) ABSTRACT

A system for implementing a local area network using passive optical networking is described. The system includes an optical line terminal (OLT), a fiber optic connection, an optical network terminal (ONT) in communication with the OLT using a passive optical networking standard, and a peripheral device directly coupled with the ONT. The ONT may include an enclosure, a first and second optical port coupled to the enclosure, an optical transceiver an optical splitter contained within the enclosure. When the ONT receives an optical signal from the OLT through the first optical port, the optical signal passes through the optical splitter, and a first portion of the split optical signal is optically coupled to the optical transceiver, and a second portion of the split optical signal exits the ONT through the second optical port in order to communicate with another ONT in the system.

### CROSS-REFERENCE TO RELATED APPLICATIONS

This application claims the benefit of U.S. Provisional Patent Application No. 61/790,353 filed Mar. 15, 2013.

### FIELD OF THE INVENTION

This invention is related to optical local area networks. In particular, this invention is related to optical local area networks over fiber optic connections using passive optical networking.

### BACKGROUND OF THE INVENTION

Resource consumption is an important factor in today's networking environment. In order to minimize costs and to meet strict regulatory requirements, network builders are increasingly becoming mindful of the infrastructure and operating costs associated with the network being laid.

Optimization is also becoming a determinative factor when designing a building's network. Commercial deployments may be required to meet strict operating and space limitations.

### SUMMARY OF THE INVENTION

The object of the invention is to provide an improved local area network using fiber optic deployment.

In one aspect, the present invention resides in a system for implementing a local area network, the system comprising: an optical line terminal (OLT); a first fiber optic connection; a passive optical splitter coupled to the OLT through the first fiber optic connection; a second fiber optic connection; an optical network terminal (ONT) in communication with the OLT using a passive optical networking standard, the ONT coupled with the passive optical splitter by the second fiber optic connection; and a peripheral device directly coupled with the ONT.

In another aspect, the present invention resides in a method for measuring power usage of an optical networking terminal (ONT) in a passive optical network (PON), the method comprising: measuring a power consumption value for determining the power usage of the ONT; and transmitting the power consumption value to an optical line terminal (OLT).

In another aspect, the present invention resides in a fiber optic cable comprising a fiber optic strand, powering means, and a terminating connector, the terminating connector comprising a terminal end of the fiber optic strand, a terminal jacket having a pair of clip receptors disposed on opposing sides of the terminal jacket; a power sheath surrounding the terminal end electrically coupled to the powering means; and a ground path integrated into the pair of clip receptors of the terminal jacket, the ground path electrically coupled to the powering means.

In yet a further aspect, the present invention resides in a fiber optic cable comprising a fiber optic strand, powering means, and a terminating connector, the terminating connector comprising: a terminal end of the fiber optic strand; a terminal jacket having a pair of clip receptors disposed on opposing sides of the terminal jacket; a power path integrated into one clip receptor of the pair of clip receptors disposed on the terminal jacket; and a ground path integrated into the other clip receptor of the pair of clip receptors, the ground path electrically coupled to the powering means.

In yet a further aspect, the present invention resides in an optical network terminal (ONT). The ONT includes an enclosure, a first optical port coupled to the enclosure, a second optical port coupled to the enclosure, a first optical transceiver coupled to a printed circuit board of the ONT for optically communicating with an optical line terminal (OLT), a first optical splitter located within the enclosure, the first optical splitter having an input, a first output and a second output. The input to the first optical splitter is optically coupled to the first optical port. The first output of the first optical splitter is optically coupled to the second optical port. The second output of the first optical splitter is optically coupled to the first optical transceiver.

In yet another aspect, the present invention resides in an optical network terminal (ONT). The ONT includes an enclosure, a first optical port coupled to the enclosure, a second optical port coupled to the enclosure, and a first optical transceiver coupled to a printed circuit board of the ONT for optically communicating with an optical line terminal (OLT). A first optical splitter is located within the enclosure. The first optical splitter is a 2:2 optical splitter having a first input, a second input, a first output and a second output. The first input to the first optical splitter is optically coupled to the first optical port. The second input to the first optical splitter is optically coupled to the optical transceiver. The first output of the first optical splitter is optically coupled to the second optical port and the second output of the first optical splitter is optically coupled to the optical transceiver.

Other devices, methods and machine-readable media are also described.

### BRIEF DESCRIPTION OF THE DRAWINGS

The disclosure is described by way of example with reference to the following accompanying drawings, wherein:

FIG. 1 shows a local area network in accordance with an embodiment of the present invention;

FIG. 2 shows an OLT connected to a plurality of daisy-chained ONTs in accordance with an embodiment of the present invention;

FIG. 3 shows two OLTs connected to a plurality of daisy-chained ONTs in accordance with an embodiment of the present invention;

FIG. 4 shows two daisy-chained ONTs in accordance with an embodiment of the present invention,

FIG. 5 shows two daisy-chained ONTs in accordance with an embodiment of the present invention with an optical signal traveling from left to right,

FIG. 6 shows two daisy-chained ONTs in accordance with an embodiment of the present invention with an optical signal traveling from right to left

FIG. 7 shows two alternate daisy-chained ONTs in accordance with an embodiment of the present invention with an optical signal traveling from left to right,

FIG. 8 shows two alternate daisy-chained ONTs in accordance with an embodiment of the present invention with an optical signal traveling from right to left,

FIG. 9 shows two alternate daisy-chained ONTs in accordance with an embodiment of the present invention using 2:2 optical splitters, and

FIG. 10 shows two alternate daisy-chained ONTs in accordance with an embodiment of the present invention using 2:2 optical splitters and an additional optical splitter.

### DETAILED DESCRIPTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Some portions of the detailed descriptions which follow are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present disclosure can relate to an apparatus for performing one or more of the operations described herein. This apparatus may be specially constructed for the required purposes such as an application specific integrated circuit (ASIC), or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing information in a form readable by a machine (e.g., a computer). For example, a machine-readable medium includes read only memory (“ROM”); random access memory (“RAM”); magnetic disk storage media; optical storage media; flash memory devices; etc.

At least certain embodiments of the present disclosure include one or application programming interfaces (API) or drivers in an environment with user interface software interacting with a software application. Various function calls or messages are transferred via the application programming interfaces between the user interface software and software applications. Transferring the function calls or messages may include issuing, initiating, invoking or receiving the function calls or messages. Example application programming interfaces transfer function calls to implement scrolling, gesturing, and animating operations for a device having a display region. An API may also implement functions having parameters, variables, or pointers. An API or driver may receive parameters as disclosed or other combinations of parameters. In addition to the APIs or drivers disclosed, other APIs or drivers individually or in combination can perform similar functionality as the disclosed APIs or drivers.

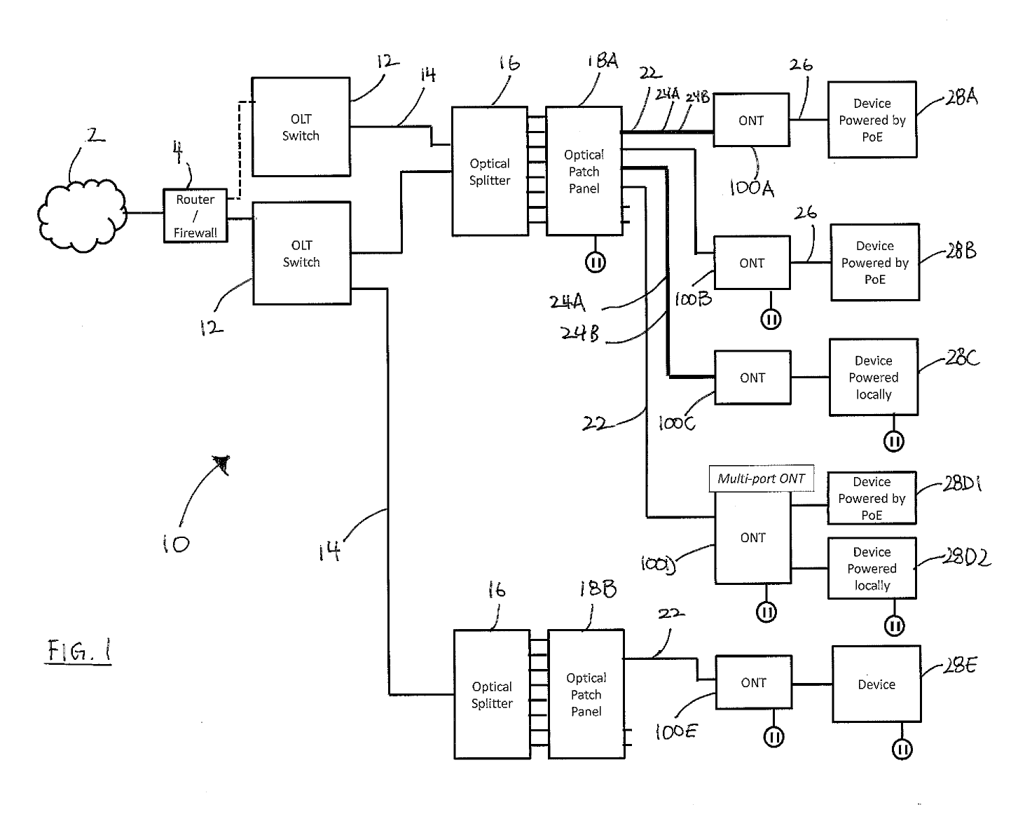

FIG. 1 illustrates a local area network 10 (LAN) using fiber optic connections in accordance with an embodiment of the present invention. The LAN 10 includes an optical line terminal 12 (OLT), optical splitter 16, and optical network terminal 100 (ONT) (shown in FIG. 1 as ONT 100A-100E). The OLT is coupled to the optical splitter 16 by a first fiber optic connection 14. Furthermore, the passive optical splitter is coupled with the ONT 100 using a second fiber optic connection 22.

The LAN 10 may be connected to external networks 2, such as the internet. In some embodiments a router/firewall 4 may be used.

Each ONT 100 is coupled with one or more peripheral devices 28 (seen in FIG. 1 as peripheral devices 28A-28E). Peripheral devices 28A-28E may include any number of types of devices for inclusion within LAN 10. For example, a peripheral device 28 may include a computer, a printer, a server and the like. In a preferred embodiment, the peripheral device 28 may be a camera, such as a security camera, connected in a LAN 10 which is designed to provide security coverage of a building, area and the like. Other possible peripheral devices 28 include access-control, smart meters, smart appliances, etc.

In some embodiments, an Ethernet cable (not shown) of the peripheral device 28 may be used to couple the peripheral device 28 to the ONT 100 over an Ethernet standard. For example, if the peripheral device is network enabled, the ONT 100 may connect to the peripheral device through the peripheral device's RJ-45 connection.

In other embodiments, the ONT may be incorporated directly into the peripheral device 28. For example, a network interface card (not shown) or proprietary connector and the like may be installed in the peripheral device 28 for coupling the ONT 100 to the peripheral device 28. For example, a small form-factor pluggable transceiver (SFP) may be used. In this manner, the ONT 100 may be installed directly in the peripheral device 28 and may be operable to communicate with the peripheral device 28 over a bus (not shown) or other communication channel, as known in the art.

The OLT 12 is in communication with the ONT 100 using a passive optical networking (PON) standard. As known in the art, a passive optical network (PON) is a point-to-multipoint network architecture which uses passive (i.e. unpowered) optical splitters to connect to peripheral devices 28 over optical fiber. In this manner, an OLT 12 is operable to enable a single optical fiber to/serve multiple peripheral devices 28. Typical PON implementations have between 16-128 peripheral devices 28. Architectures utilizing a PON reduce the amount of fiber and related infrastructure required to connect network in comparison to point-to-point architectures.

Any suitable version of a PON standard may be used. For example, the PON standard may be the Gigabit Passive Optical Networks (GPON) standard developed by the International Telecommunication Union (ITU) or the Ethernet Passive Optical Networks (EPON) standard developed by the Institute of Electrical and Electronics Engineers (IEEE). Other flavours of PON such as APON, 10G-PON, 10G-EPON, SPON and the like may also be used.

Packets may be passed in the LAN 10 amongst the peripheral devices 28. In this manner, the OLT behaves as a layer 2 (L2) switch (i.e. data link layer) in the Open Systems Interconnection (OSI) model, while providing the benefits of an optical infrastructure including long reach, smaller and lighter cables, fewer cables, and resistance to lightning and electrostatic discharge (ESD).

In addition, using an OLT 12 with fiber optic transmission paths to implement the LAN 10 is desirable in that optical fiber is expected to become cheaper than unshielded twisted pair (UTP) cabling, as the cost of metals and other natural resources required by ethernet cabling and the like increases.

As also shown in FIG. 1, the LAN 10 may include a powered patch panel 18A or unpowered patch panel 18B coupled to the passive optical splitter 16. The patch panels 18 may be coupled between the passive optical splitter 16 and one or more of the ONT 100. The patch panels 18 are configured to allow a plurality of ONT 100 to be plugged and unplugged into the LAN 10 over a plurality of second fiber optic connections 22. It should be understood that a patch panel 18 is not a requirement and the ONT 100 of the LAN 10 may connect directly to the optical splitter 16 via the second fiber optic connections 22.

In a preferred embodiment, the LAN 10 may include a powered patch panel 18A which is configured to provide power to one or more ONT 100 and the associated peripheral devices 28. For example, the second fiber optic connection 22 may include a fiber optic cable 24A for passing data and messages between the powered patch panel 18A and the ONT 100 and a powering means 24B for transmitting or providing power from the powered patch panel 18A to the ONT 100. The powering means 24B may provide AC or DC power and may include two or more electrical wires (not shown). For example, if the second fiber optic connection 22 provides DC power, one of the electrical wires may be a grounding wire (GND) and a second wire may be a DC voltage (VDD). In this manner, the ONT 100 and/or the peripheral device 28 may draw power from the second fiber optic connection 22 connected to the powered patch panel 18A.

In another embodiment, the power means 24B may provide AC power or three-phase AC power and include the appropriate number of wires, as would be known in the art.

The ONT 100 may communicate with peripheral device 28 over an electrical connection, such as over an ethernet standard. In this case, power may be supplied to the peripheral device 28 using a power over ethernet (PoE) standard. The power provided to the peripheral device may be provided from the powered patch panel 18A. In this manner, the ONT 100 and the peripheral device 28 may be powered solely from the powered patch panel 18A, without requiring local power.

In at least one preferred embodiment, the ONT 100 is configured to incorporate the PoE circuitry necessary to draw, supply and power the PoE connection to the peripheral device 28. The circuit board of the ONT 100 (not shown) is configured to convert the power received from the power means 24B to power both the circuit board and the peripheral device 28.

Referring back to FIG. 1, different configurations for powering the ONT 100 and peripheral devices 28 are possible in various embodiments.

In one embodiment, the ONT 100A is powered by the powered patch panel 18A. Power from the powered patch panel 18A is provided to the ONT 100A by the second fiber optic connection 22. As discussed the second fiber optic connection 22 may include the fiber optic cable 24A and powering means 24B. The powering means 24B may provide enough power to the ONT 100A to power the ONT 100A. Furthermore, the power provided to the ONT 100A by the powering means 24B may also power the peripheral device 28A. In some embodiments, the peripheral device 28C may still be powered locally, even if the corresponding ONT 100C is powered by the powered patch panel 18A.

In another embodiment, the ONT 100B may be locally powered. For example, the ONT 100B may be plugged into a wall electrical socket and the like to receive AC or DC power. In some embodiments, an AC/DC converter may be used. If the ONT 100B/100D is locally powered, the peripheral device 28B/28D1 may be powered by the ONT 100B/100D. In some embodiments, the peripheral device, such as peripheral device 28D2, may still be powered locally, even if the corresponding ONT 100D is locally powered. In this manner, both the ONT 100D and the peripheral device 28D2 are locally powered, separately.

In yet a further embodiment, an unpowered patch panel 18B may be used and the ONT 100E may be locally powered. Furthermore, the corresponding peripheral device 28E may also be locally powered, or may receive power from the ONT 100E.

While specific configurations have been described, it should be understood that other configurations may be possible. Furthermore, as shown with respect to the ONT 100D, multiple peripheral devices 28D1/28D2 may be coupled to a single ONT 100. If multiple peripheral devices 28 are coupled to an ONT 100, it should be understood that various combinations of powered and unpowered peripheral devices 28 are possible.

Once received by the OLT 12, the power consumption values obtained from the ONTs 100 may be tabulated to determine the total amount of power drawn from the powered patch panel 18A by the ONTs 100 in the LAN 10. The values may be taken a fixed intervals to determine the overall power usage of the LAN 100.

Furthermore, when a plurality of ONT 100 are utilized, the OLT 12 may provide an interface for monitoring the power usage. For example, the OLT 12 may provide an online interface for the real-time monitoring of power being drawn from the powered patch panel 18A or the OLT 12. In this manner, a user of the LAN 10 can identify specific peripheral devices 28 and/or the OLT 12 as drawing different levels of power and can adjust power levels of the LAN 10 accordingly.

In addition to the real-time monitoring of power drawn by the OLT 12 and/or the peripheral devices 28, the online interface is configured to allow real-time monitoring and control of the OLT 12 and the associated ONT 100 in the optical LAN 10. Various implementations of network management systems may be used, as known in the art. In addition, multiple LANs using a plurality of OLT 12 may be used in combination to control larger LANs or even wide area networks (WANs). The online interface, such as a hosted or cloud controller, can enable a user to manage and monitor the network offsite or anywhere in the world.

The LAN 10 is configured to manage the connection and disconnections of peripheral devices 28 to the network. In a preferred embodiment, the LAN 10 may be configured as a black box to hide from the external user that connections to the OLT 12 occur over an optical connection (i.e. first and second fiber optic connections 14/22). Instead, any peripheral device 28 connected to the LAN 10 may see only Ethernet connections to the LAN 10. Any connections over fiber are invisible to the peripheral device and end user.

To enable such functionality, in a preferred embodiment, the OLT 12 and ONT 100 may be configured to enable and disable optical links based on whether a corresponding Ethernet link has been established between the ONT 100 and the corresponding peripheral device 28. If no Ethernet link has been established, the OLT 12 is configured to consider the optical link with the specific ONT 100 down or disconnected for the purposes of network management. Only when a peripheral device 28 has been connected to the ONT 100 over an Ethernet link will the OLT 12 register the optical link as connected to the LAN 10.

In addition, to ensure that the peripheral device 28 does not begin transmitting information to the ONT 100 before the optical link between the ONT 100 and the OLT 12 is established, the ONT 100 is configured to hold the status of the Ethernet connection in a disconnected state until the corresponding optical link between the ONT 100 and the OLT 12 is established and configured to pass traffic. Only then will the ONT 100 indicate to the peripheral device 28 that the Ethernet link has been established and is correspondingly enabled. In this manner, the peripheral device 28 cannot begin sending traffic to the ONT 100 over the established Ethernet connection until the corresponding optical link to the OLT 12 has also been established.

In addition, in a preferred embodiment, the ONT 100 is configured to send an event or interrupt over the second fiber optic link 22 to the OLT 12 to indicate that a connection with a peripheral device 28 has been established and that the corresponding ONT 100 wants to establish communications with the OLT 12. Different methods of communication this indication with the OLT 12 may be used. For example, the OLT may set aside certain time periods that the ONT 100 may use to indicate it wishes to establish an optical link. In an alternative example, the OLT 12 may set aside a certain time period in which an interrupt may be used to force the OLT 12 to send out a discover broadcast for all devices wishing to establish a connection to the OLT 12. In an alternative embodiment, the OLT 12 may use counters or polling to receive an indication that an ONT 100 wishes to establish communications with the OLT 12 and for the OLT 12 to register the ONT 100.

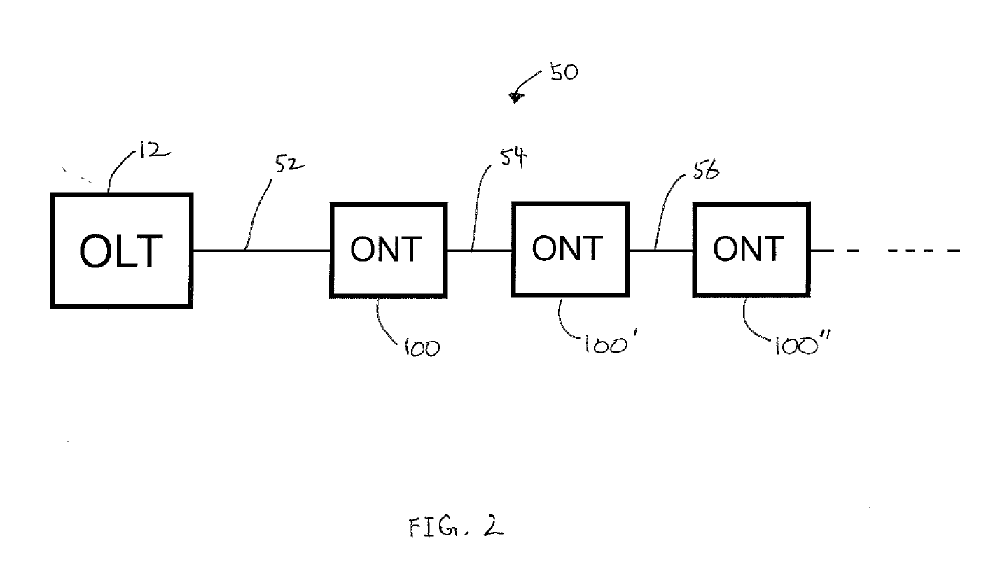

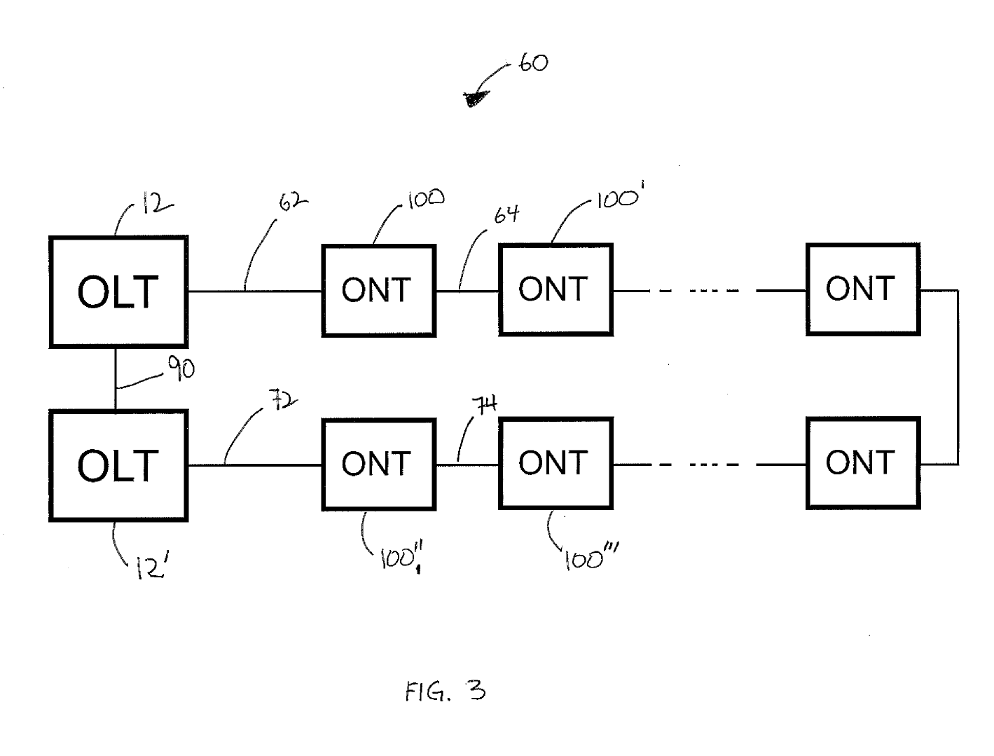

In a preferred embodiment, alternate LANs 50/60 may be implemented as shown in FIGS. 2 and 3. The networking topology of LAN 50 utilizes passive daisy-chaining, where the optical signal from OLT 12 traveling along fiber optic connection 52 passes into ONT 100 and then out of ONT 100 to the next ONT 100′ through fiber optic connection 54 and onto the next ONT 100″ through fiber optic connection 56.

As known in the art, an optical port 101 allows the optical signal to enter the ONT 100 and reach the transceiver 102. The optical port 101 specifically aligns the optical channel from the transceiver 102 to the optical channel in the external fiber connection (such as second fiber connection 22). Different form factors of optical ports or connectors may be used. For example, SC connectors, LC connectors, MTP connectors and the like may be utilized.

Once inside the ONT 100, the optical signal is converted to an electrical signal by transceiver 102. The transceiver 102 may be electrically coupled to a printed circuit board (PCB) to allow the converted electrical signal to be operated on. Furthermore, the electrical signal may then be passed to a peripheral device 28. In the opposite direction, an electrical signal may be converted to an optical signal by the transceiver 102. Accordingly, the transceiver may be capable of both transmitting and receiving optical and electrical signals.

Different form factors of transceivers 102 may be used. For example, a bi-directional sub assembly (BOSA) may be used. Other laser assemblies are also possible. The different types of laser assemblies may require different types of fiber connections. As would be understood in the art, the described embodiments use single mode bi-directional fiber. However, it should be understood that other variants may be employed. For example, multi-mode fiber may be used. Similarly, duplex connectors with separate transmission paths for uplink and downlink may be employed.

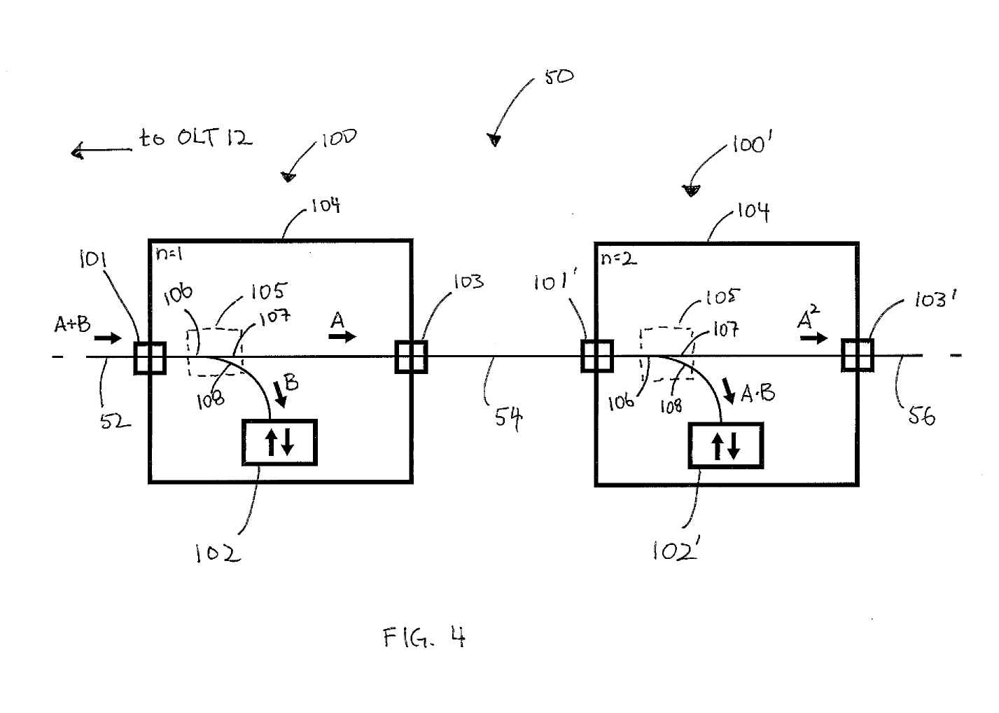

Referring now to FIG. 4, the optical signal from the OLT 12 is passed from left to right. After the optical signal enters the first optical port 101, the signal is split using an optical splitter 105. As shown in FIG. 4, a 1:2 optical splitters is used. A portion of the split optical signal goes to the optical transceiver 102. The remaining portion of the split optical signal exits the ONT 100 through the second optical port 103. The remaining portion may then go to the next ONT 100′ in the daisy-chain.

The optical splitter 105 may be located within the enclosure 104. The optical splitter 105 has an input 106, a first output 107 and a second output 108. The input 106 to the optical splitter is optically coupled to the first optical port 101. Furthermore, the first output 107 of the optical splitter 105 is optically coupled to the second optical port 103 and the second output 108 of the optical splitter 105 is optically coupled to the optical transceiver 102.

As known by persons skilled in the art, an optical splitter 105 is a device capable of splitting a received optical signal. When a light signal enters the optical splitter 105 through the input 106, the light source is split and exits the optical splitter 105 through both the first output 107 and the second output 108. The information exiting the first output 107 and the second output 108 is the same, but the intensity (or optical power) of the signal may be different and related to the split ratio between the first output 107 and the second output 108. In particular, for a symmetric splitter, 50 percent of the light goes out each of the first output 107 and the second output 108. For an asymmetric splitter, different proportions of the optical input power is split to each of the first output 107 and the second output 108 of the optical splitter 105.

In the opposite direction, light that enters an output 107/108 of the optical splitter 105 is not attenuated in the same manner as when the signal is received at the input 106. Instead, the signals from both outputs 107/108 are merged together and exit the splitter through the input 106. It should be understood that all splitters suffer from optical loss. Furthermore, there is optical signal degradation in the optical fiber and across the optical ports 101/103.

In at least one embodiment using the optical splitter 105 within the enclosure 104 of the ONT 100, the optical splitter 105 is asymmetric. Instead of equally splitting the optical signal 50/50 such that 50% of the optical signal is terminated at the optical transceiver 102 and the other 50% is passed to the ONT 100′, the optical splitter 105 is asymmetric and uses an asymmetric ratio (such as 3%/97% or 5%/95% or 10%/90% and the like), such that the received optical power to the ONT 100 from the OLT 12 (i.e. 3% or 5%) is split from the optical signal and the remaining optical signal (i.e. 97% or 95%, respectively) through the second optical port 103 is used to communicate with one or more other ONT 100′ further down the daisy chain. In this manner, the asymmetric optical splitter 105 within the enclosure of the ONT 100 allows more optical splits to be used when multiple ONT 100 are daisy-chained together before the signal integrity of the optical signal deteriorates below a usable level or minimum threshold of received signal strength.

As should be understood by a skilled person in the art, the return path of the optical signal from the optical transceiver 102 to the OLT 12 may go in reverse through the optical channel described. When an electrical signal is received from a peripheral device 28 and converted to be an optical signal by the transceiver 102, the optical signal is sent from the optical transceiver 102. There is no degradation of the optical signal to the OLT 12, as there are no optical splits along the return path. Instead the optical signals are simply merged onto the same fiber optic connection 52 on their way back to the OLT 12.

Returning now to FIG. 3, an alternate form of daisy-chaining is shown. In LAN 60, the optical signal from OLT 12 traveling along fiber optic connection 62 passes into ONT 100 and then out to the next ONT 100′ through fiber optic connection 64. However, LAN 60 uses a second OLT 12′ for redundancy purposes.

OLT 12 and OLT 12′ may be configured to operate in tandem over connection 90. Connection 90 may be any type of communication connection such as, for example, an Ethernet cable or a fiber optic cable and the two OLT 12/12′ may coordinate together to automatically switch over if a connection to an ONT 100 is discovered. For example, the two OLTs 12/12′ may communicate to determine which OLT 12/12′ is master and which OLT 12/12′ is slave, and then the slave OLT 12/12′ may take over connectivity to the ONTs 100 if the master OLT 12/12′ goes offline.

To enable redundancy, each ONT 100/100′/100″/100′″ has two separate paths to either OLT 12/12′. For example, looking at FIG. 3, the LAN 60 allows communication in both directions (clockwise and counter-clockwise). In this manner if an OLT 12/12′ goes down, the alternate OLT 12/12′ may take over. Similarly, if a fiber connection 62/64/72/74 between ONTs 100/100′/100″/100′″ gets cut (i.e. if fiber connection 64 gets cut), the alternate OLT 12/12′ may provide connectivity to the isolated ONTs 100/100′/100″/100′″ in the opposite direction (i.e. ONT 100′ is still accessible via OLT 12′). In such a situation, both OLT 12/12′ may be utilized simultaneously.

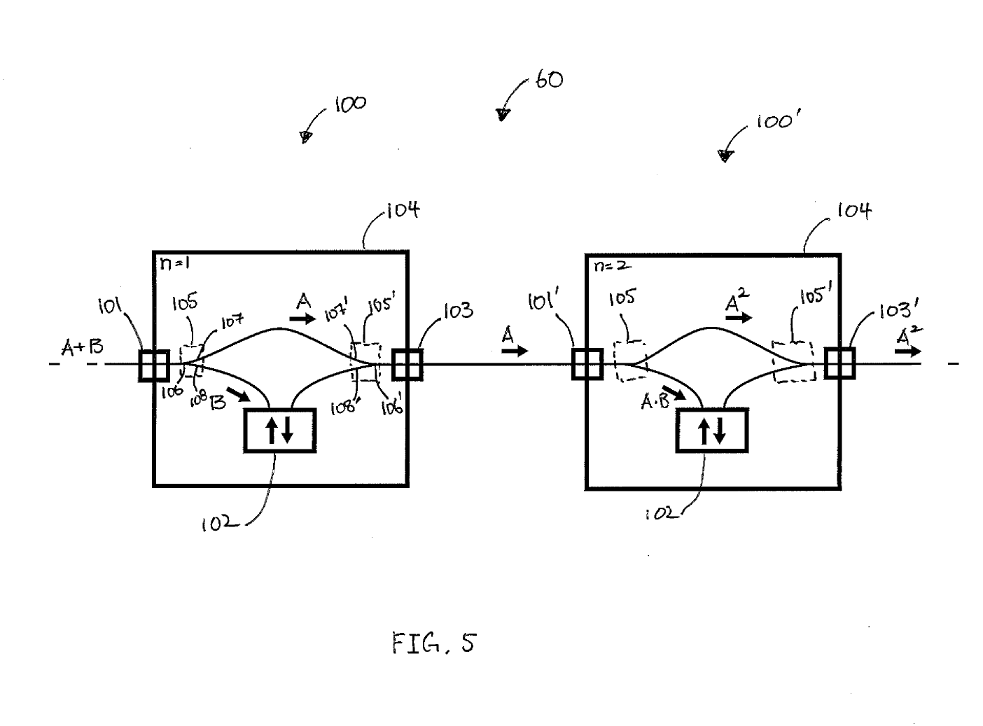

To allow such functionality in a preferred embodiment, the ONT 100 may integrate one or more optical splitters within its enclosure 104 to allow for daisy chaining of ONTs, as shown in FIGS. 5 to 10. In this manner, the ONT 100 would incorporate two optical ports, a first optical port 101 (i.e. an incoming port) to connect the ONT 100 to the OLT 12 (or earlier ONT) and a second optical port 103 (i.e. outgoing port) for connecting the ONT 100 to another ONT 100′. Such a method allows for better daisy-chaining of a plurality of ONTs 100, as the optical splitter 105 and ONT 100 are within a single enclosure and the optical splitter 105 may be better protected from the elements, such as the weather and dirt/dust when compared to an external splitter.

In at least one embodiment using a plurality of daisy-chained ONT 100, as shown in FIGS. 5 to 10, the portion of the optical signal continuing on to the next ONT 100 in the chain and the portion of the optical signal received by the optical transceiver 102 may be described with the following formulae:
At ONT n:

Optical power entering ONT 1=A+B;

Optical power transmitted on to ONT n+1=Aⁿ; and

Optical power received by optical transceiver 102 of ONT n=Aⁿ⁻¹*B;

where A and B are fractional percentages (Splitter A:B),

where A>B and where A+B=100.

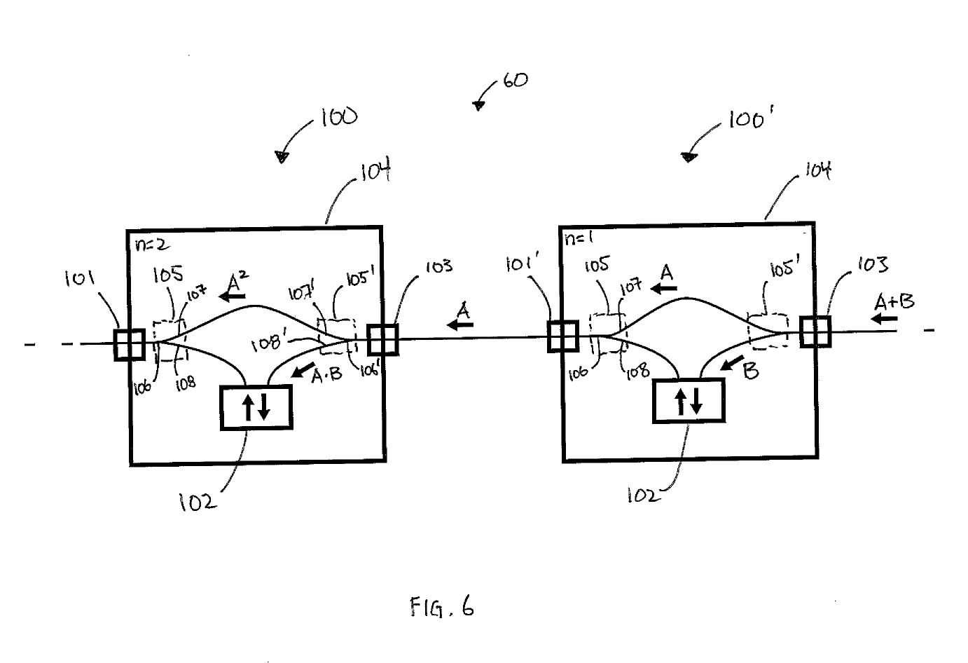

Referring now to FIGS. 5 and 6, each ONT 100/100′ incorporates two optical splitters 105/105′. As seen in FIG. 5, the two optical splitters 105/105′ are configured in a mirror configuration. Each ONT 100/100′ is configured such that an incoming optical signal is split once depending on whether the optical signal enters the ONT 100/100′ from the first optical port 101/101′ or the second optical port 103/103′. If the signal enters from the first optical port 101/101′, the optical signal is split by the optical splitter 105. If the optical signal enters the ONT 100/100′ from the second optical port 103/103′, the optical signal is split by the optical splitter 105′. Accordingly, the optical transceiver 102 of each ONT 100/100′ is configured to receive optical signal from either the first optical port 101/101′ or the second optical port 103/103′, depending on the source of the optical signal.

In other words, for ONT 100 seen in FIG. 5, the first optical splitter 105 has an input 106, a first output 107 and a second output 108. The input 106 to the first optical splitter 105 is optically coupled to the first optical port 101. The second optical splitter 105′ has an input 106′, a first output 107′ and a second output 108′. The input to the second optical splitter 105′ is optically coupled to the second optical port 103. The second output 108′ of the second optical splitter 105′ is optically coupled to the optical transceiver 102.

Different from the ONT 100 shown in FIG. 4, the first output 107 of the first optical splitter 105 is optically coupled to the first output 107′ of the second optical splitter 105′. In this manner, the optical signal exiting the first output 107 of the first optical splitter 105 enters the first output 107′ of the second optical splitter 105′, flows through the input 106′ of the optical splitter 105′ and, subsequently, exits the ONT 100 through the second optical port 103.

As seen in FIG. 5, the optical flow of the optical signal is from left to right. For n=1 (i.e. ONT 1), the optical power entering the first optical port 101 of ONT 1 is A+B. Using the optical splitter 105, the optical signal transmitted to ONT 2 through the second optical port 103 is A and the optical signal transmitted to the optical transceiver 102 of ONT 1 is B. At ONT 2, the optical power transmitted on to ONT 3 through the second optical port 103′ is A², while the power transmitted to the optical transceiver 102 of ONT 2 is A*B. In other words, the optical signal received at the transceiver 102 of ONT 2 is proportional to the signal entering the ONT 100′ and is directly related to the split ratio of the optical splitter 105 of ONT 2.

Referring now to FIG. 6, the same topology seen in FIG. 5 is used; however, the light now travels from right to left. As depicted, the same topology allows a flow of the optical signal from right to left to occur in the same manner described above for FIG. 5. It should be understood that the numbering of ONTs 100/100′ has changed.

As with FIG. 5, the optical power transmitted to ONT 2 from the first port 101′ of ONT 1 is A and the optical power transmitted to the optical transceiver 102 of ONT 1 is B. Similarly, the optical power transmitted from the first port 101 of ONT 2 (i.e. exiting ONT 2) to ONT 3 is A², while the power transmitted to the optical transceiver 102 of ONT 2 is A*B.

Referring to FIG. 5 and FIG. 6, it should be understood that the topology shown is symmetric and that an optical signal flowing in either direction (i.e. from left to right or right to left) will be asymmetrically split such that a portion of the optical signal will be sent to the optical transceiver 102 of the ONT 100/100′ and the remaining portion of the optical signal will be sent to the ONT 100/100′ next in line (in either direction). Accordingly, it should be understood that such a topology allows for redundancy such that either end of the daisy-chained LAN 60 may be connected to a different optical port of OLT 12 (not shown) or different OLTs 12 such as illustrated in FIG. 3.

In such topologies, the LAN 60 has the option of communicating with each ONT 100 from either direction. Using redundancy, where either end of the daisy-chained LAN 60 is connected to OLT 12, the configuration allows the LAN 60 to overcome any single break in a fiber optic connection. If a break occurs, the OLT 12 has the option to communicate with the ONT from the opposite, unbroken direction.

It should be understood by a person skilled in the art that communications with an OLT 12 or multiple OLTs 12/12′ cannot occur in both directions (i.e. left to right and right to left) at the same time. Instead, the OLT 12 must intelligently choose which direction to access the transceiver 102 at any given time, in order to avoid collisions.

Referring again to FIGS. 5 and 6, the optical transceiver 102 ONT 100 receives the optical signal from both the second output 108 of the first optical splitter 105 and the second output 108′ of the second optical splitter 105′. In some embodiments, the ONT 100 may have two optical transceivers 102 (not shown) to receive these two signals. In such configurations, the second output 108 of the first optical splitter 105 interfaces or is optically coupled with first transceiver and the second output 108′ of the second optical splitter 105′ interfaces or is optically coupled with the second transceiver (not shown).

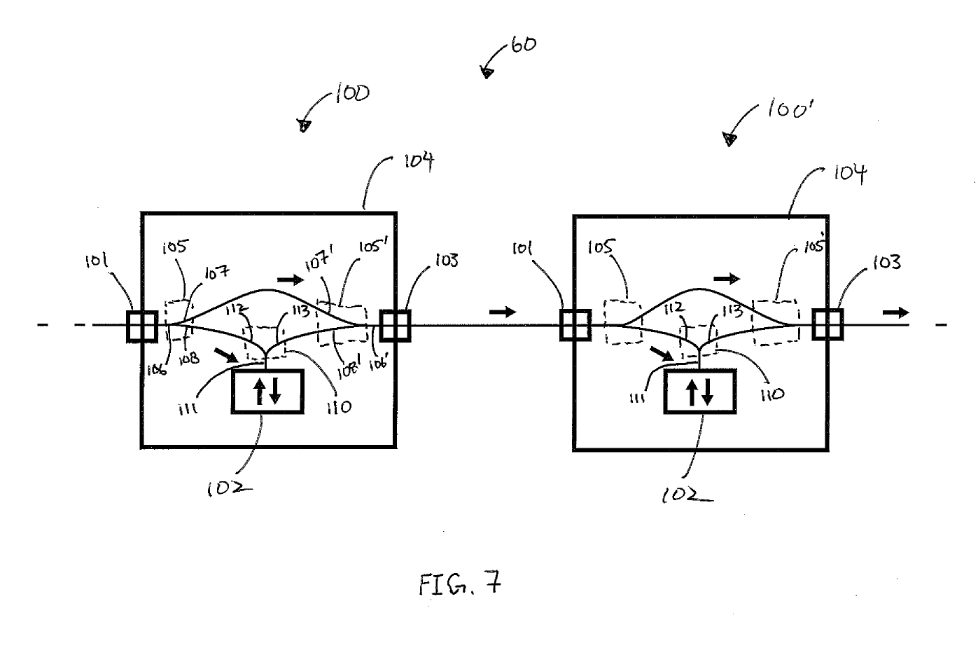

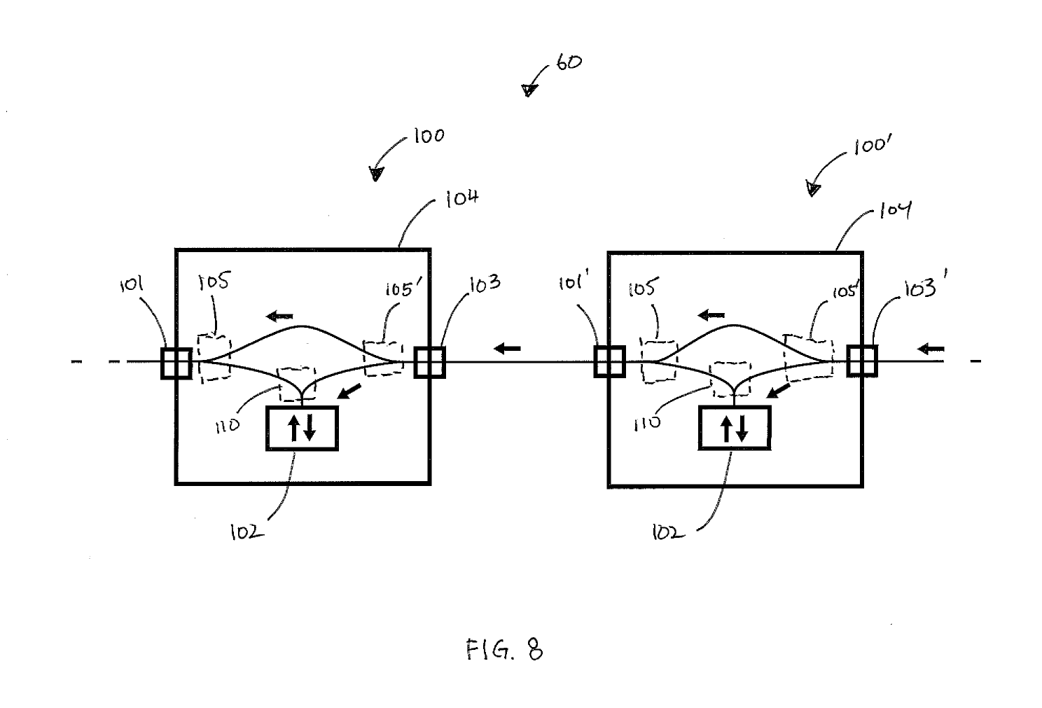

Referring briefly now to FIGS. 7 and 8, a third optical splitter 110 is shown in an alternate embodiment of the present invention. The third optical splitter 110 may allow the ONT 100 to use a single optical transceiver 102. The third optical splitter 110 has an input 111, a first output 112 and a second output 113.

As shown in FIGS. 7 and 8, the input 111 to the third optical splitter 110 is optically coupled to the optical transceiver 102. Furthermore, the first output 112 of the third optical splitter 110 is optically coupled to the second output 108 of the first optical splitter 105 and the second output 113 of the third optical splitter 110 is optically coupled to the second output 108′ of the second optical splitter 105′.

It should be understood that such a configuration as seen in FIGS. 7 and 8 may result in optical collisions if more than one OLT 12 is transmitting at the same time from both directions. However, intelligent control of the OLT 12 may allow the ONT 100 to utilize less components.

The third optical splitter 110 may be symmetric (i.e. 50:50) or asymmetric. A symmetric third optical splitter 110 may allow for redundancy, while an asymmetric splitter 110 may improve performance and/or configurability of LAN 60 or simply allow for different daisy-chain topographies.

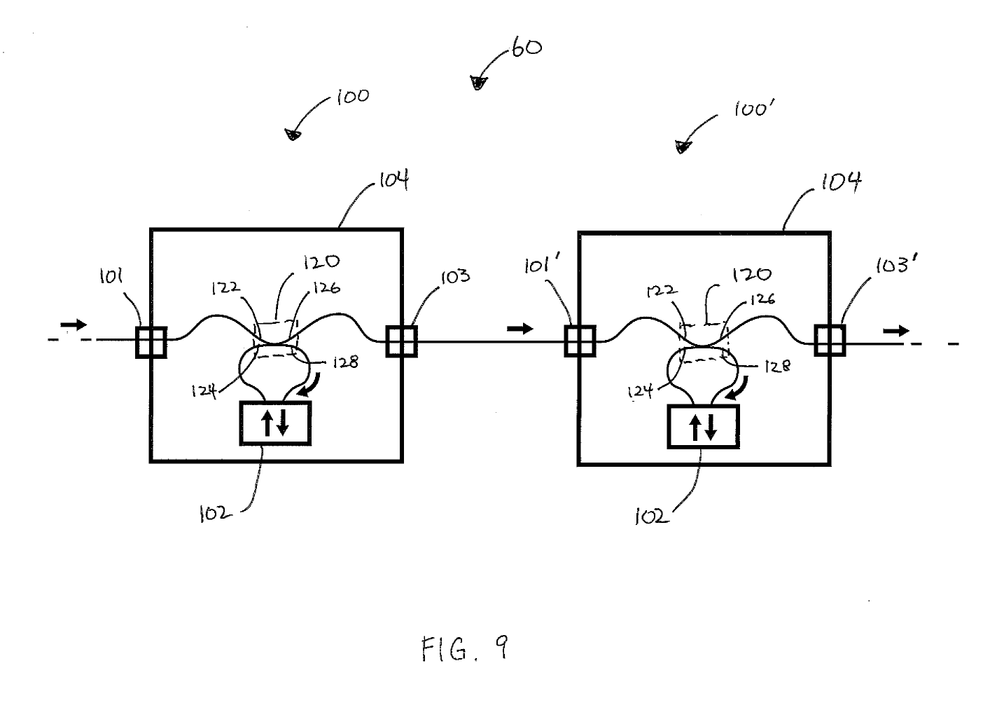

Referring now to FIG. 9, an alternative topology for an ONT 100 is shown where a 2:2 optical splitters 120 is used. In such a topology only a single optical splitter 120 is required inside each ONT 100/100′. This may result in a smaller ONT 100 form factor or may minimize difficulties in production.

It should be understood that the 2:2 optical splitter 120 may be formed by connecting two optical splitters 105 (as seen in FIGS. 5 to 8) together. If the inputs 106 of two optical splitters 105 were connected together (not shown), the functionality of a 2:2 optical splitter 120 could be replicated with separate splitters.

As shown in FIG. 9, the 2:2 optical splitter 120 has a first input 122, a second input 124, a first output 126 and a second output 128. The first input 122 to the optical splitter 120 is optically coupled to the first optical port 101. The second input 124 to the optical splitter 120 is optically coupled to the optical transceiver 102. The first output 126 of the optical splitter 120 is optically coupled to the second optical port 103. The second output 128 of the optical splitter 120 is optically coupled to the optical transceiver 102.

In operation, the 2:2 optical splitter 120 behaves as two typical splitters 105 seen in FIGS. 5 to 8 with the inputs connected. An optical signal entering the first input 122 is split between the first output 126 and the second output 128. Similarly, an optical signal from the transceiver 102 entering the second input 124 is split between the first output 126 and the second output 128. The split ratio between the first output 126 and the second output 128 affects both the first input 122 and the second input 124.

A similar behaviour is seen in the opposite direction. An optical signal entering the first output 126 from the second optical port 103 enters the first output 126 and is split between the first input 122 and the second input 124. Similarly, an optical signal from the transceiver 102 entering the second output 128 is split between the first input 122 and the second input 124.

As would be apparent by a person skilled in the art, the topology of ONT 100 seen in FIG. 9 is improved if the 2:2 optical splitter 120 is asymmetric and allows for effective daisy-chaining in both directions. In particular, from left to right, if the split ratio between the first output 126 and the second input 128 is such that the majority of the light continued on through the first output 126 to the next ONT 100 through the second optical port 103, many ONTs 100 could be daisy-chained together in this direction.

Similarly, from right to left, if the split ration between the first input 122 and the second input 124 is such that the majority of light entering the first output 126 continued on through the first input 122 to the next ONT 100 through the first optical 101, many ONTs 100 could be daisy-chained together in this direction.

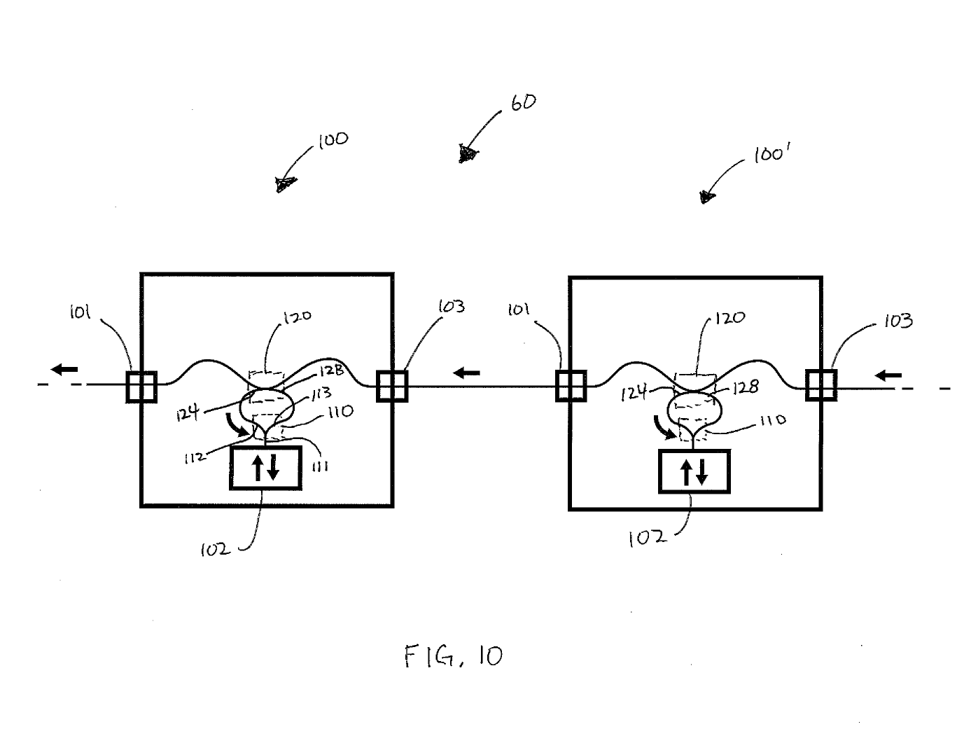

In a preferred embodiment, the split ratios of the first input 122 over the second input 124 and the first output 126 over the second output 128 are very high. For example, split ratios of 97:3 and 95:5 may be used. In this manner, many ONT 100, as depicted in FIGS. 9 and 10, may be daisy-chained together. Other asymmetries may also be used.

Referring briefly now to FIG. 10, a second optical splitter 110 is shown in an alternate embodiment, in combination with the 2:2 optical splitter 120 seen in FIG. 9. The second optical splitter 110 may allow the ONT 100 to use a single optical transceiver 102. The second optical splitter 110 has an input 111, a first output 112 and a second output 113.

As shown in FIG. 10, the input 111 to the second optical splitter 110 is optically coupled to the optical transceiver 102. Furthermore, the first output 112 of the second optical splitter 110 is optically coupled to the second input 124 of the 2:2 optical splitter 120 and the second output 113 of the second optical splitter 110 is optically coupled to the second output 128 of the 2:2 optical splitter 120.

It should be understood that such a configuration as seen in FIG. 10 may result in optical collisions if more than one OLT 12 is transmitting at the same time from both directions. However, intelligent control of the OLT 12 may allow the ONT 100 to utilize less components.

Furthermore, in alternate embodiments, the optical splitter 110 may be symmetric (i.e. 50:50) or asymmetric. A symmetric optical splitter 110 may allow for redundancy, while an asymmetric splitter 110 may improve performance and/or configurability of LAN 60 or simply allow for different daisy-chain topographies, as would be understood by persons skilled in the art.

In the foregoing specification, the disclosure has been described with reference to specific exemplary embodiments thereof. It will be evident that various modifications may be made thereto without departing from the broader scope of the disclosure as set forth in the following claims. The scope of the claims should not be limited by the preferred embodiments set forth in the examples, but should be given the broadest interpretation consistent with the description as a whole. The specification and drawings are, accordingly, to be regarded in an illustrative sense rather than a restrictive sense.

1. A system for implementing a local area network, the system comprising:
an optical line terminal (OLT);
a fiber optic connection;
an optical network terminal (ONT) in communication with the OLT using a passive optical networking standard; and
a peripheral device directly coupled with the ONT,
wherein the ONT further comprises:
an enclosure;
a first optical port coupled to the enclosure;
a second optical port coupled to the enclosure;
an optical transceiver for communicating with the OLT; and
an optical splitter contained within the enclosure;
wherein the ONT receives an optical signal from the OLT through the first optical port,
the optical signal passes through the optical splitter,
a first portion of the split optical signal is optically coupled to the optical transceiver, and
a second portion of the split optical signal exits the ONT through the second optical port in order to communicate with another ONT in the system.

2. The system of claim 1, wherein a plurality of ONT are daisy-chained together.

3. The system of claim 1, wherein the optical splitter contained within the enclosure of the ONT is asymmetric.

4. The system of claim 3, wherein the ONT is configured such that the optical signal is enabled to enter the ONT through either the first optical port or the second optical port and be asymmetrically split.

5. The system of claim 4, wherein the optical splitter is a 2:2 optical splitter.

6. The system of claim 4, wherein the ONT comprises a pair of the optical splitter configured in a mirror configuration such that the optical signal is enabled to enter the ONT through either the first optical port or the second optical port and be asymmetrically split.

7. An optical network terminal (ONT) comprising:
an enclosure;
a first optical port coupled to the enclosure;
a second optical port coupled to the enclosure;
a first optical transceiver coupled to a printed circuit board of the ONT for optically communicating with an optical line terminal (OLT);
a first optical splitter located within the enclosure, the first optical splitter having an input, a first output and a second output;
wherein the input to the first optical splitter is optically coupled to the first optical port,
wherein the first output of the first optical splitter is optically coupled to the second optical port, and
wherein the second output of the first optical splitter is optically coupled to the first optical transceiver.

8. The ONT of claim 7, wherein the ONT communicates with the OLT over a passive optical networking standard.

9. The ONT of claim 7, wherein the first optical splitter is symmetric.

10. The ONT of claim 7, wherein the first optical splitter is asymmetric.

11. The ONT of claim 10, wherein the first optical splitter has a split ratio selected from the group of 97:3 and 95:5.

12. The ONT of claim 7, wherein the ONT further comprises a second optical splitter located within the enclosure, the second optical splitter having an input, a first output and a second output;
wherein the input to the second optical splitter is optically coupled to the second optical port,
wherein the first output of the second optical splitter is optically coupled to the first output of the first optical splitter, and
wherein the second output of the second optical splitter is optically coupled to the optical transceiver.

13. The ONT of claim 12, wherein the second optical splitter is asymmetric and has a split ratio selected from the group of 97:3 and 95:5.

14. The ONT of claim 12, wherein the ONT further comprise a second optical transceiver coupled to the printed circuit board of the ONT for optically communicating with the OLT,
wherein the first optical transceiver is optically coupled to the second output of the first optical splitter, and
wherein the second optical transceiver is optically coupled to the second output of the second optical splitter.

15. The ONT of claim 12, wherein the ONT further comprises a third optical splitter having an input, a first output and a second output,
wherein the input to the third optical splitter is optically coupled to the optical transceiver,
wherein the first output of the third optical splitter is optically coupled to the second output of the first optical splitter, and
wherein the second output of the third optical splitter is optically coupled to the second output of the second optical splitter.

16. The ONT of claim 15, wherein the third optical splitter is asymmetric and has a split ratio selected from the group of 97:3 and 95:5.

17. An optical network terminal (ONT) comprising:
an enclosure;
a first optical port coupled to the enclosure;
a second optical port coupled to the enclosure;
a first optical transceiver coupled to a printed circuit board of the ONT for optically communicating with an optical line terminal (OLT);
a first optical splitter located within the enclosure, wherein the first optical splitter is a 2:2 optical splitter having a first input, a second input, a first output and a second output;
wherein the first input to the first optical splitter is optically coupled to the first optical port,
wherein the second input to the first optical splitter is optically coupled to the optical transceiver,
wherein the first output of the first optical splitter is optically coupled to the second optical port, and
wherein the second output of the first optical splitter is optically coupled to the optical transceiver.

18. The ONT of claim 17, wherein the first optical splitter is asymmetric
wherein the first output of the first optical splitter receives a majority of the light from a light signal entering either the first input or the second input, and
wherein the first input of the first optical splitter receives the majority of the light from the light signal entering either the first output or the second output.

19. The ONT of claim 17, wherein the ONT further comprises a second optical transceiver coupled to the printed circuit board of the ONT for optically communicating with the OLT, wherein the second input of the first optical splitter is optically coupled with the first optical transceiver and the second output of the first optical splitter is optically coupled to the second optical transceiver.

20. The ONT of claim 17 further comprising a second optical splitter having an input, a first output and a second output,
wherein the input to the second optical splitter is optically coupled to the first optical transceiver,
wherein the first output of the second optical splitter is optically coupled to the second input of the first optical splitter, and
wherein the second output of the second optical splitter is optically coupled to the second output of the first optical splitter.
